(19) United States
(12) Patent Application Publication
(10) Pub. No.: US 2021/0081946 A1
(43) Pub. Date: Mar. 18, 2021

(54) Methods and Systems for Facilitating Microcredit for Processing a Payment Transaction

(71) Applicant: Mastercard Labs Kenya Holdings PTE. LTD., Singapore (SG)

(72) Inventors: Daniel Huba Opondo, Nairobi (KE); Benard Munyiri, Nairobi (KE); Ojo K. Oluwasogo, Ruaka (KE); Edwin Kaduki, Nairobi (KE); Shola Sanni, Ikoyi (NG)

(21) Appl. No.: 17/017,141

(22) Filed: Sep. 10, 2020

(30) Foreign Application Priority Data
Sep. 12, 2019 (SG) 10201908437P

(51) Int. Cl. G06Q 20/40; G06Q 20/24; G06F 9/54

(52) U.S. Cl. CPC G06Q 20/4014; G06F 9/547; G06Q 20/24

(57) ABSTRACT

Embodiments provide methods, and systems for facilitating microcredit for processing a payment transaction. The method includes receiving, by a server system associated with a payment network, a payment transaction request initiated using a machine-readable optical label from a user device of a user. The payment transaction request includes a merchant ID of a merchant and a transaction amount. The method includes detecting an insufficient balance in an issuer account of the user. The method includes verifying, using the merchant ID, if the merchant is enabled to receive a microcredit based payment via the machine-readable optical label. the method includes facilitating a microcredit offer of a loan amount on the user device for user acceptance. Upon user acceptance of the microcredit offer, the method includes facilitating a payment transaction of the transaction amount from the issuer account of the user to an acquirer account of the merchant.

### TECHNICAL FIELD

The present disclosure relates to processing an electronic payment transaction for payment of goods and/or services in a payment transaction management network and, more particularly to, methods and systems for facilitating microcredit to consumer for processing the payment transaction via a machine-readable optical label.

### BACKGROUND

The Bottom of Pyramid (BoP) is a term typically used for a significant proportion of the global population living on low incomes compared to the costs incurred to meet their basic needs. Usually, because of poverty and location, an unemployed or low-income individual does not otherwise gain access to financial services. In scenarios, when a BoP customer with no cash money or a payment card (e.g., a credit card or a debit card) is at a merchant facility for purchasing a product/service, he/she may have to walk away without purchasing the product at all or he/she may have to request for goods with a promise to pay later based on a personal relationship with the merchant. The downside of this is that it results in a loss of sale on the merchant side or the merchant is left bearing the burden of credit on his constrained capital for giving away the product without receiving the payment. Therefore, Small and Medium-Sized Enterprises (SMEs) and Micro-SMEs (often having less than ten employers) market get widely affected with a majority of the customer falling in the BoP category.

An affordable transaction or a bank account is the first step towards financial inclusion and providing BoP customers with a route to a broader range of financial services. An example of the financial service being provided to the BoP customer is microfinance. Microfinance covers the provision of savings accounts, loans, insurance, money transfers, and other banking services to customers who lack access to traditional financial services. Microcredit is the extension of very small loans (e.g., microloans) to impoverished borrowers who typically lack steady employment or a verifiable credit history. Microcredit is designed to support entrepreneurship and alleviate poverty.

Gradually, banks, payment card networks, and mobile network operators have started using digital technology, like mobile phones, to distribute banking services to the BoP customers from where the BoP customers can purchase or consume services from a merchant. Accordingly, techniques are desired for providing a business model extension for low-income micro-SME and SME market with an affordable mobile platform to leverage the banking services. Further, the techniques are desired for providing a mobile banking based microcredit to the BoP customers dynamically for purchasing the products with seamless customer experience.

### SUMMARY

Various embodiments of the present disclosure provide systems, methods, electronic devices and computer program products for facilitating microcredit for processing a payment transaction.

In an embodiment, a computer-implemented method is disclosed. The method includes receiving, by a server system associated with a payment network, a payment transaction request initiated using a machine-readable optical label from a user device of a user. The payment transaction request at least includes a merchant ID associated with a merchant and a transaction amount. The method includes detecting, by the server system, an insufficient balance in an issuer account of the user. The method includes verifying, using the merchant ID, by the server system, if the merchant is enabled to receive a microcredit based payment via the machine-readable optical label. Upon successful verification, the method includes facilitating, by the server system, a microcredit offer on the user device for user acceptance. The microcredit offer includes a loan amount to be used for processing the payment transaction request. Upon user acceptance of the microcredit offer, the method includes facilitating, by the server system, a payment transaction of the transaction amount from the issuer account of the user to an acquirer account of the merchant.

In another embodiment, a server system is provided. The server system includes a communication interface configured to receive a payment transaction request initiated using a machine-readable optical label from a user device of a user. The payment transaction request at least includes a merchant ID associated with a merchant and a transaction amount. The server system further includes a memory comprising executable instructions and a processor communicably coupled to the communication interface. The processor is configured to execute the instructions to cause the server system at least to detect an insufficient balance in an issuer account of the user. The processor is further configured to execute the instructions to cause the server system to verify, using the merchant ID, if the merchant is enabled to receive a microcredit based payment via the machine-readable optical label. Upon successful verification, the server system is further caused to facilitate a microcredit offer on the user device for user acceptance. The microcredit offer includes a loan amount to be used for processing the payment transaction request. Upon user acceptance of the microcredit offer, the server system is further caused to facilitate a payment transaction of the transaction amount from the issuer account of the user to an acquirer account of the merchant.

In yet another embodiment, a yet another server system is disclosed. The server system includes a communication module configured to receive a registration request for registering a merchant to receive a microcredit based payment via a machine-readable optical label. The registration request includes a plurality of merchant parameters. The communication module is further configured to receive a verification request to verify if a merchant is registered to receive the microcredit based payment via the machine-readable optical label. The verification request includes a merchant ID received as a part of a payment transaction request initiated by a user device of a user via the machine-readable optical label. The payment transaction request includes a transaction amount. The server system further includes a storage module comprising executable instructions and a processing module communicably coupled to the communication module. The processing module is configured to execute the instructions to cause the server system at least to facilitate generation of the machine-readable optical label by the merchant. The machine-readable optical label is to be scanned by the user to initiate the payment transaction request. The processing module is further configured to execute the instructions to cause the server system to facilitate one or more merchant registration Application Program Interfaces (APIs) to enable the merchant to register for receiving the microcredit based payment via the machine-readable optical label. The server system is further caused to assign a merchant ID to the merchant. The merchant ID is mapped with the plurality of merchant parameters in a mapping database. The server system is further caused to verify if the assigned merchant ID matches with the merchant ID received in the payment transaction request. Upon successful match, a payment transaction of the transaction amount from an issuer account of the user to an acquirer account of the merchant is facilitated.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIG. 2 represents a sequence flow diagram for facilitating microcredit for processing a payment transaction, in accordance with an example embodiment;

FIG. 3 represents a sequence flow diagram representing an assignment of a merchant ID to a merchant, in accordance with an example embodiment;

FIG. 4 represents an example representation of a payment process flow using a microcredit offer displayed on a mobile phone of a user with corresponding User Interfaces (UIs), in accordance with an example embodiment;

FIG. 5 represents a simplified schematic representation of an example UI of a registration request of a merchant to receive a microcredit based payment via a machine-readable optical label, in accordance with an example embodiment;

FIG. 6 illustrates a flow diagram of a method for facilitating microcredit for processing a payment transaction, in accordance with an example embodiment;

FIG. 7 is a simplified block diagram of a server system, in accordance with one embodiment of the present disclosure;

FIG. 8 is a simplified block diagram of an issuer server, in accordance with one embodiment of the present disclosure;

FIG. 9 is a simplified block diagram of an acquirer server, in accordance with one embodiment of the present disclosure;

FIG. 10 is a simplified block diagram of a payment server, in accordance with one embodiment of the present disclosure; and

FIG. 11 represents a simplified block diagram of a user device capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refer to a financial account that is used to fund the financial transaction (interchangeably referred to as “payment transaction”). Examples of the payment account include, but is not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment network”, used throughout the description, refer to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Overview

Various example embodiments of the present disclosure provide methods, systems, user devices and computer program products for facilitating microcredit for processing a payment transaction via a machine-readable optical label.

In various example embodiments, the present disclosure facilitates a server system in a payment network that receives a payment transaction request initiated from a user device using a wallet application for purchasing a product or a service. The server system is an issuer server configured to facilitate an issuer account to the user. The wallet application may be enabled to receive the payment transaction request via a machine-readable optical label. Example of the machine-readable optical label include a Quick Response (QR) Code. A QR code is a two-dimensional barcode that contains data for a locator, an identifier, or a tracker that points to a website or an application, in this case, the wallet application. Further, the wallet application may be facilitated by the issuer server or a third-party wallet server or a payment server associated with the payment network. The payment transaction request includes a merchant ID associated with a merchant and a transaction amount among various other information. The issuer server is configured to verify available balance in the issuer account of the user to process the payment transaction request.

In one embodiment, the server system being the payment server is configured to facilitate one or more merchant registration Application Program Interfaces (APIs) are configured to enable a merchant to register for receiving a microcredit based payment via the machine-readable optical label. The payment server receives a registration request for registering the merchant using the APIs from an acquirer server or a merchant device. The registration request includes a plurality of merchant parameters. Some non-exhaustive examples of the merchant parameters include a merchant name, a merchant category code, a merchant city, a merchant postal code, a merchant brand name, a merchant primary account number (PAN), and a request ID. Subsequently, the payment server is configured to assign a merchant ID to the merchant. The merchant ID is mapped with the plurality of merchant parameters in a mapping database. The payment server also facilitates generation of the machine-readable optical label to be scanned by the user device by the merchant to initiate the payment transaction request.

In one scenario, the issuer server detects an insufficient balance in the issuer account of the user. In one embodiment, upon detecting insufficient balance in the issuer account, the issuer server sends the merchant ID received in the payment transaction request to the payment server to verify if the merchant is enabled to receive the microcredit based payment via the machine-readable optical label. The payment server is configured to match the merchant ID with the assigned merchant ID (mapped with the plurality of merchant parameters from the mapping database.) Based on detection of the insufficient balance in the issuer account and upon successful verification of the merchant, the issuer server is configured to facilitate a microcredit offer on the user device for user acceptance. The microcredit offer includes a loan amount, an interest rate and a plurality of terms and conditions applicable to the microcredit offer. A credit limit is set prior to facilitating the microcredit offer on the user device. The credit limit is set based on analyzing an existence time period of the issuer account and a number of transactions processed using the issuer account during the existence time period.

Upon user acceptance of the microcredit offer, the issuer server is configured to credit the issuer account with the loan amount. The issuer server debits the transaction amount from the loan amount present in the issuer account and credits the transaction amount to the acquirer account of the merchant. Thus, a payment transaction of the transaction amount from the issuer account of the user to an acquirer account of the merchant is facilitated by the issuer server.

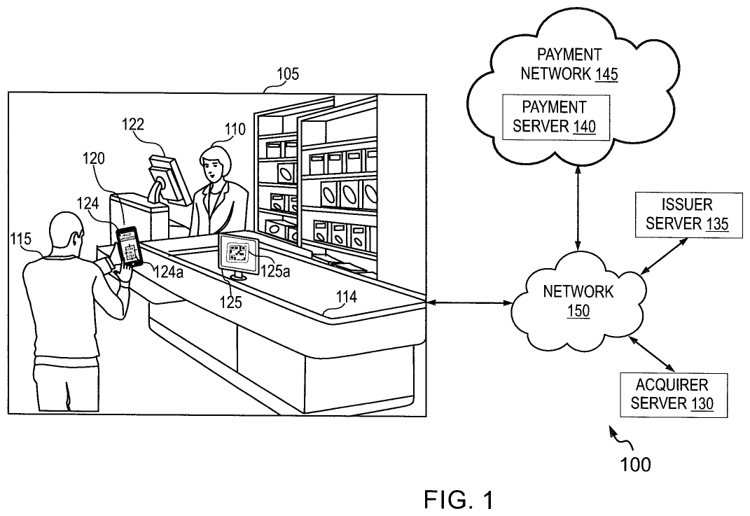

Various example embodiments of present disclosure are described hereinafter with reference to FIGS. 1 to 11.

FIG. 1 illustrates an exemplary representation of an environment 100 related to at least some example embodiments of the present disclosure. In the illustrated embodiment, a facility 105 is shown. Examples of the facility 105 may include any retail shop, supermarket or establishment, government and/or private agencies, ticket counters, SMEs, micro-SMEs, or any such place or establishment where users visit for performing financial transaction in exchange of any goods and/or services or any transaction that requires financial transaction between the user and the facility 105.

As shown, a customer 115 (hereinafter referred to as user 115) is standing near a payment desk 114 to make the financial transaction to a merchant 110 with a willingness to purchase a product from the facility 105. In a non-limiting example, the user 115 is a BoP customer with no or limited cash money or no payment cards to be able to make purchase at the facility 105. The merchant 110 has placed a display board 125 with a QR code 125a (an example of a machine-readable optical label) printed on the display board 125. The QR code 125a can be placed at one or more other places of the facility 105 so as to make it easily visible to the users. For instance, the QR code 125a can be pasted on wall, can be mounted on queue dividers, or displayed on a display screen of a merchant device 122 in the facility 105. The merchant device 122 is shown to be a desktop computer. In other embodiments, it may be a mobile phone or any other electronic device capable of processing the QR code based payment transactions. In some embodiments, instead of a static QR code such as the QR code 125a, a dynamic QR code may be generated using the merchant device 122 per transaction such that, after scanning the dynamic QR code, the user 115 does not need to enter the transaction amount, but only have to pay the displayed transaction amount using his device.

The user 115 is shown to be using a wallet application 124 on his user device such as a mobile phone 120. The user device 120 and mobile phone 120 are used interchangeably throughout the present description. However, the user device 120 may be any electronic device such as, but not limited to, a personal computer (PC), a tablet device, a Personal Digital Assistant (PDA), a voice activated assistant, a Virtual Reality (VR) device, a smartphone and a laptop. The wallet application 124 typically requires authentication/authorization of the wallet user at the time of purchase. For example, using a UI facilitated by the wallet server, the user is enabled to enter a username, a password, a PIN or a fingerprint to authenticate himself. Further, during enrollment, the wallet application 124 requires the user 115 to provide sensitive information such as personal information, contact information, financial information and the like. The wallet application 124 may include at least one payment account therein that is issued by an issuer (e.g., on an issuer server 135) which may correspond to a bank, a credit agency, or other type of financial institution.

The wallet application 124 includes an actionable icon 124a displayed with text, ‘scan the QR code’. The user 115 may click the actionable icon 124a to initiate the scanning of the QR code 125a using the wallet application 124. A camera (not shown) of the mobile phone 120 is used by the wallet application 124 to scan the QR code 125a. The mobile phone 120 can be a feature phone with limited functionalities or a smartphone with internet connectivity. In other embodiments, the mobile phone 120 can be any electronic device capable of utilizing various communication technologies such as Unstructured Supplementary Service Data (USSD) technology, SMS technology, Wi-Fi, mobile network data etc. for processing payment transactions using the QR codes.

The user 115 initiates a payment transaction request by scanning the QR code 125a. The wallet application 124 receives the QR code information and parses the information to display the next applicable UIs (not shown) on the mobile phone 120. For example, the user 115 may be requested to enter payment transaction details such as a transaction amount, an MPIN and the like. Further, the parsed QR code information may include a merchant ID of the merchant 110. In a non-limiting example, verification of the MPIN and user's account balance for making a transaction of ‘X’ amount to facilitate completion of the payment transaction is performed by an issuer server 135.

In an example embodiment, the issuer server 135 also facilitates the wallet application 124 capable of performing the QR code based payment transactions. In another example embodiment, the wallet application 124 may be facilitated by a third-party wallet server (not shown) through a digital platform. The issuer server 135 is associated with a financial institution normally called as an “issuer bank” or “issuing bank” or simply “issuer”, in which the user 115 may have an account, (which also issues a payment card, such as a credit card or a debit card), and provides microfinance banking services (e.g., microcredit offers) for processing electronic payment transactions, to the user 115. For example, if the issuer account of the user 115 does not have sufficient balance to process the payment transaction at the facility 105, the issuer server 135 is configured to facilitate/display a microcredit offer at run time on the user device 120 for user acceptance. If the user accepts the offer, a loan amount is credited to the issuer account using which the transaction amount is recovered to process the payment transaction.

To accept payment from the user 115, the merchant 110 must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank. The acquirer server 130 is also configured to register the merchant 110 to accept a microcredit based payment via the QR code.

In one embodiment, a payment server 140 associated with a payment network 145 is shown. The payment network 145 may be used by the payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.). Further, Masterpass® QR (MPQR) is a Mastercard Person-to-Merchant payment solution that is integrated into issuer's mobile banking platform. Using MPQR solution, consumers are enabled to make cashless payments from their smartphones by simply scanning a Masterpass® QR code (e.g., QR code 125a) at any Masterpass® QR-accepting merchant location (e.g., facility 105). Using MPQR solution, the merchants are enabled to onboard themselves to receive microcredit based payments via the QR codes.

Using the payment network 145, the computers of the issuer server 135 communicate with the computers of the acquirer server 130. The acquirer server 130 further communicates with the issuer server 135 to determine whether the user's account is in good standing and whether the purchase is covered by the user's available account balance. Based on these determinations, authorization of the payment transaction is declined or accepted. When the authorization is accepted, the available balance of the user's account is decreased. After a transaction is captured, the transaction is settled between the merchant, the acquirer and the issuer. Settlement refers to the transfer of financial data or funds between the merchant's account, the acquirer, and the issuer, related to the transaction. However, if the purchase is not covered by the available balance of the user's account, the issuer server 135 facilitates a microcredit offer on the user device 120 to process the payment transaction instead of completely declining the authorization.

The user device (i.e., the mobile phone 120 of the user 115), the merchant device (i.e., the desktop computer 122), the issuer server 135, the acquirer server 130 and the payment server 140 communicate with one another using a network 150. The network 150 may be a centralized network or may comprise a plurality of sub-networks that may offer a direct communication or may offer indirect communication. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, personal communication services (“PCS”), infrared communications, global area networks, or other suitable networks, etc., or any combination of two or more such networks.

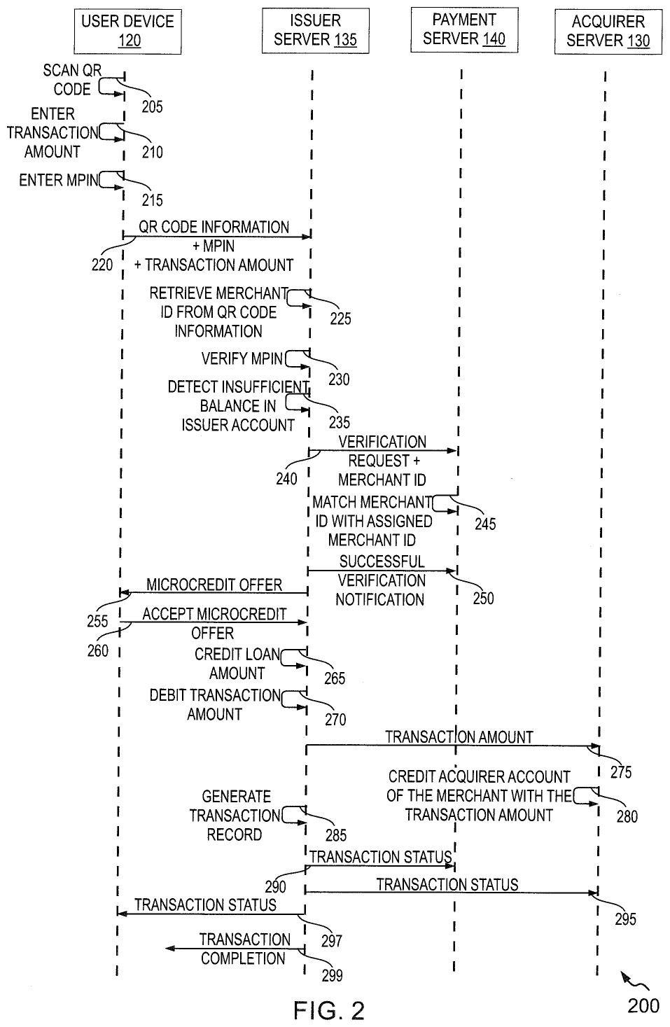

Since the user 115 is only needed to scan the QR code 125a, and accept a microcredit offer with low interest rates issued by the issuer server 135 during the payment transaction, the overall transaction flow is effortless for both the merchant 110 and the user 115 for completing the payment transaction. In scenarios, when the user 115 has zero balance in his account, he can still pay using the loan amount received as part of the microcredit offer, as issuing authorities of microcredit allow free credit period of, for example, 50 days to repay the loan amount. With technology being more ubiquitous, it is becoming economically efficient for the issuing institutes to lend tiny amounts of money to people with even tinier assets. Some non-exhaustive example embodiments of facilitating microcredit for processing payment transaction are described with reference to FIGS. 2 to 11.

FIG. 2 represents a sequence flow diagram 200 for facilitating microcredit for processing a payment transaction, in accordance with an example embodiment. The sequence of operations of the flow diagram 200 may not be necessarily executed in the same order as they are presented. Further, one or more operations may be grouped together and performed in form of a single step, or one operation may have several sub-steps that may be performed in parallel or in sequential manner.

At 205, the mobile phone 120 scans a QR code using a wallet application stored in the mobile phone 120. As explained with reference to FIG. 1, the mobile phone camera is used by the wallet application 124 to scan the QR code 125 displayed by the merchant 110 in the facility 105 to process the payment transaction. The wallet application uses a QR scan library to detect and scan a QR code with the device camera. The wallet application is further configured to decode the scanned image and return an MPQR-compliant object. This object is required to perform the push payment to the merchant and among various other information, it at least includes a merchant ID of the merchant (hereinafter alternatively referred to as QR information). The merchant ID can be any numerical, alphanumerical, code or any identifier that is unique to identify the merchant.

At 210, the user enters a transaction amount using a UI on the user device 120 as facilitated by the wallet application. If a merchant has opted for a dynamic QR code generation method, then this step is skipped as the merchant himself enters the transaction amount for generating the QR code of a particular payment transaction.

At 215, the user enters a Mobile Personal Identification Number (MPIN) using another UI facilitated by the wallet application. MPIN is a four-digit code issued by the issuer bank to the user while registering for the electronic payment transactions. MPIN is used to authenticate the user's identity and association with the issuer bank. In an alternate example embodiment, the user is requested to enter a transaction amount and an MPIN using one or more corresponding UIs on the mobile phone as displayed by the issuer server 135 via a wireless carrier such as a mobile network operator or a cellular company that delivers wireless communication services such as a USSD messaging or SMS messaging to the users of the mobile phone which is a feature phone and not a smart phone.

At 220, the QR information, the transaction amount and the MPIN are sent to the issuer server 135. At 225, the issuer server 135 is configured to retrieve the merchant ID of the merchant from the QR information by parsing the QR information.

At 230, the issuer server 135 is configured to verify the MPIN. In one example embodiment, the issuer server 135 retrieves additional information associated with the user account for identifying his spending pattern and credit worthiness. In an embodiment, upon successful verification of the MPIN, the issuer server 135 debits the transaction amount entered by the user from his bank account by approving the transaction amount for the payment transaction. If the MPIN entered by the user is incorrect, the issuer server 135 is configured to request the user to re-enter the MPIN using a corresponding UI.

At 235, the issuer server 135 detects insufficient balance in the issuer account of the user. This means the user is unable to purchase the product at the facility 105. To overcome this problem, at 240, the issuer server 135 sends the merchant ID and a verification request to the payment server 140. The verification request is for verifying if the merchant is registered to receive a microcredit based payment via the machine-readable optical label i.e., the QR code.

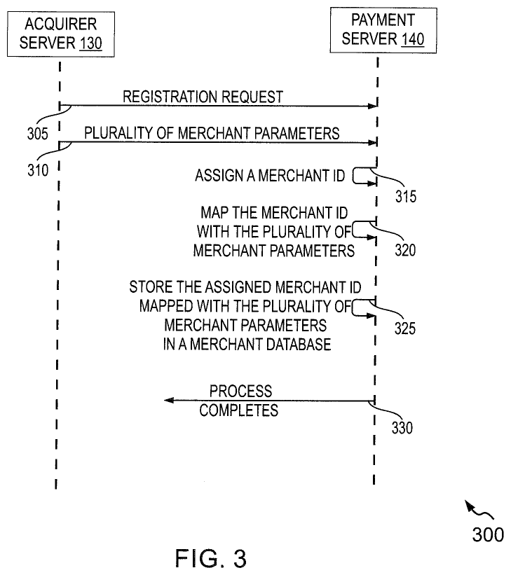

At 245, the payment server 140 matches the merchant ID with an assigned merchant ID of the merchant to verify if the merchant is registered to receive the microcredit based payment via the QR code. The assignment of the merchant ID is explained in detail later with reference to FIG. 3.

At 250, the payment server 140 sends a notification of a successful verification to the issuer server 135 upon matching the merchant ID with the assigned merchant ID.

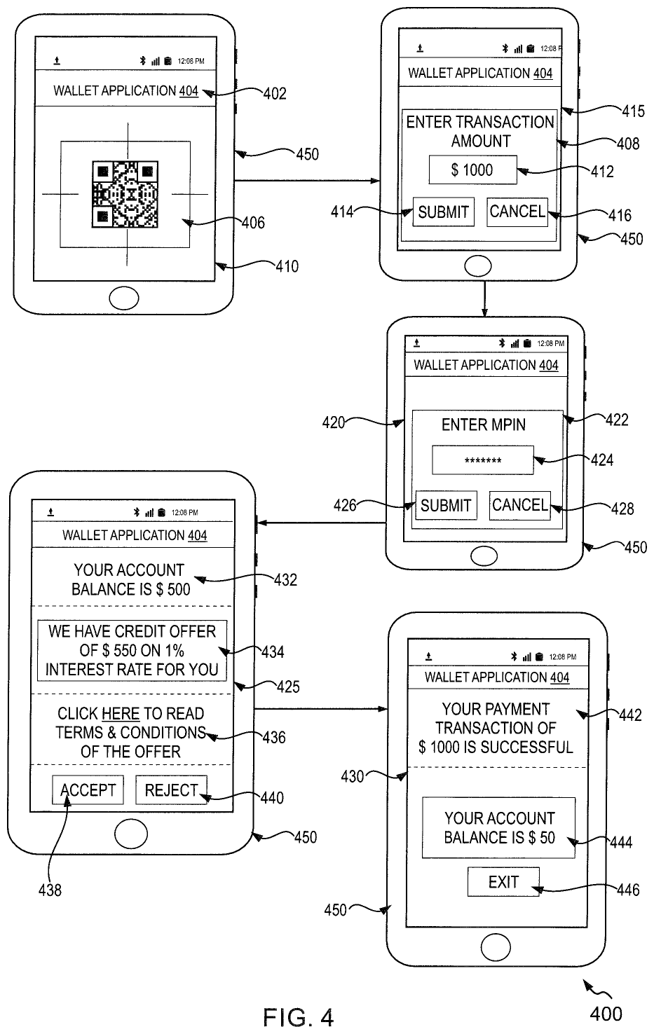

At 255, the issuer server 135 displays a microcredit offer using a corresponding UI on the user device 120. Prior to displaying the microcredit offer, the issuer server 135 is configured to set a credit limit based on analyzing various parameters. Examples of the parameters include an existence time period of the issuer account, a number of transactions processed using the issuer account during the existence time period and the like. For example, if a user has an issuer account for a period of last ten years and during these ten years, the user has made a minimum of two transactions every month, then the user is considered to have good spending history. For such user, a higher credit limit with lower interest rate may be set for offering the microcredit to the user. For example, if the issuer account has $240 and the transaction amount is $250 of the prospective purchase, a credit limit of $100 may be set even if the difference between the account balance amount and transaction amount is only $10. On the contrary, if a user has mostly an inactive/a very less active payment account for a long period of time, then the credit limit for such user may be set to only $10 or $15 considering the above example. Offering of the microcredit on the user device 120 is explained in detail with reference to FIG. 4 later.

At 260, the mobile phone 120 sends acceptance of the microcredit offer to the issuer server 135. At 265, the issuer server 135 credits a loan amount in the issuer account. Considering the above example of the user with a good spending history, a loan amount of $100 may be credited such that the available account balance becomes $340. At 270, the issuer server 135 debits the transaction amount from the loan amount present in the issuer account. Therefore, the transaction amount of $250 is debited from the account balance amount $340 to process the transaction.

At 275, the issuer server 135 sends the transaction amount to the acquirer server 130. Further, the issuer server 135 may also send the merchant Primary Account Number (PAN) to the acquirer server 130 for crediting the transaction to the merchant account. At 280, the acquirer server 130 credits the acquirer account of the merchant with the transaction amount. The acquirer server 130 is configured to store a plurality of merchant parameters including the merchant ID and the merchant PAN. The acquirer server 130 may optionally notify the issuer server 135 and the payment server 140 of crediting of the payment transaction amount.

At 285, the issuer server 135 generates a transaction record. The transaction record includes a transaction status (i.e., successful, failure or pending) of the payment transaction. For example, if the transaction fails for some reason, the issuer server 135 reverses the transaction amount cleared by it back to the issuer account of the user.

At 290, the issuer server 135 sends the transaction status to the payment server. At 295, the issuer server 135 sends the transaction status to the acquirer server 130. At 297, the issuer server 135 sends the transaction status further to the mobile phone 120 of the user. The payment transaction completes at operation 299. In one embodiment, if the merchant is using a dedicated application facilitated by the payment server 140 or the acquirer server 130 in his device, the merchant may be immediately enabled to view the transaction status using the application on his device. The merchant may access the application using a web link as well, instead of having a need to install the application on his device. In other embodiments, the merchant may be notified using an SMS from the acquirer server 130 of the transaction status.

In an example embodiment, the transaction is captured by the payment server 140. The transaction is settled between the merchant (e.g., the merchant 110 of FIG. 1), the acquirer bank, and the issuer bank. Settlement refers to the transfer of financial data or funds between the merchant's account, the acquirer bank and the issuer bank related to the transaction. Usually, transactions are captured and accumulated into a “batch”, which is settled as a group. The actual transaction amount used by the user can be settled in batches even after the user leaves the merchant facility.

Thus, a technical effect of dynamically facilitating the microcredit on the user device for processing the payment transaction results in a time saving and more simplified solution for the merchants as well as the users. Various embodiments of the present disclosure facilitate a partnership model to the merchant such that the risk of consumer credit management is completely shifted from an average shopkeeper/merchant to a financial institution/issuer bank whose core business is to issue and manage credits. Accordingly, the merchant's working capital is liberated, and cost of debt collection is completely removed. Similarly, the consumer with limited income or no liquid finance is still enabled to meet his daily needs by receiving microcredits and repaying them off later.

FIG. 3 represents a sequence flow diagram 300 representing an assignment of a merchant ID to a merchant, in accordance with an example embodiment. At 305, the acquirer server 130 (on behalf of the merchant) sends a registration request to register the merchant to receive the microcredit based payment via the QR code using network such as the network 150 of FIG. 1.

At 310, a plurality of merchant parameters are sent to the payment server 140 along with the registration request. It is noted that the operations 305 and 310 can be performed in a single step. In an embodiment, the payment server 140 is configured to facilitate one or more merchant registration Application Program Interfaces (APIs) to enable the merchant to register for receiving the microcredit based payment via the machine-readable optical label. The payment server 140 is further configured to facilitate generation of the machine-readable optical label/QR code to be scanned by the user device to initiate the payment transaction request by the merchant. The merchant ID request and the merchant parameters are sent using indicative API calls from the acquirer server 130 to the payment server 140. For instance, a request may be in form of:
Request=(“apiOperation”:“RequestMicrocrecitbasedpayment”,“RequestQRcodebasedpayment”,“RequestMerchantID”, “RequestID”:“ABC 123”,“MerchantPan”:“5555444433331110”,“MerchantName”:“TestMerchant1”,“MCC”: “6531”,“MerchantCity”:“Nairobi”,“MerchantPostalCode”:“110014”,“MerchantBrandName”:“MEGAMART”)

As mentioned in the exemplary API request above, for a request ID—‘ABC123’, a plurality of parameters associated with the merchant include merchant PAN, merchant name, merchant category code (MCC), merchant city, merchant postal code, merchant brand name and the like. One or more of the plurality of merchant parameters are used by the acquirer server 130 to credit the transaction amount in the acquirer account of the merchant.

At 315, the payment server 140 is configured to assign a unique merchant ID for the request ID received from the acquirer server 130. An API response from the payment server 140 to the acquirer server 130 may be such as—
Response=(“MerchantID”:“12345678”,“Status”:“SUCCESS”,“MerchantPan”:“5555444433331110”, “RequestID”:“ABC123”)

As can be seen from the API response, for the request ID—‘ABC123’, the assigned merchant ID is ‘12345678’.

At 320, the assigned merchant ID is mapped to the plurality of merchant parameters. In one example, instead of performing API calls, the Mastercard® payment system may facilitate a plurality of Mastercard integration processors (MIPs) locally installed at each acquirer bank and perform as a link between the Mastercard® payment system interchange network and the processing services. The MIPs may be configured to facilitate on request creation of the merchant ID. In various embodiments, the merchant ID may be generated by an acquirer processor/the acquirer server 130 associated with the acquirer bank.

At 325, the assigned merchant ID, mapped with the plurality of merchant parameters, are stored in a merchant database. The process completes at step 330. In various embodiments of the present disclosure, the merchant ID is used to identify the merchant during the normal processing of payment transactions, adjustments, chargebacks, end-of-month fees and so forth. The merchant ID is different than other merchant account numbers, particularly those that identify merchants to the equipment (e.g., point-of-sale (POS) terminals or any other electronic devices) they use for processing transactions. A merchant with a single merchant processing account number may use several terminals at one location, resulting in one merchant ID and several terminal identification numbers (TIDs).

In at least one embodiment, the assigned merchant ID (e.g., ‘12345678’) is matched by the payment server 140 with a merchant ID received in the payment transaction request as sent by the issuer server 135. Only upon successful match, the payment server 140 notifies the issuer server 135 that the merchant is registered to receive microcredit based payments via the QR codes. Upon receiving the successful verification notification, the issuer server 135 displays an applicable microcredit on the user device 120 for user acceptance and the payment transaction is completed.

FIG. 4 represents an example representation of a payment process flow 400 using a microcredit offer displayed on a mobile phone 450 of a user with corresponding User Interfaces (UIs), in accordance with an example embodiment.

A UI 410 displays a header 402 of a wallet application 404 and a QR code 406 being scanned by the user (not shown). Prior to displaying the UI 410, the wallet application 404 may display an actionable icon (not shown) represented “scan the QR code” (such as the actionable icon 124a of FIG. 1). When the user selects the actionable icon, the wallet application 404 takes control of a camera application of the mobile phone 450 to use the phone camera to scan the QR code 406 as shown in the UI 410. The user may also scan (or electronically read) a QR code associated with a POS terminal (not shown) of the merchant facility. For instance, a QR code corresponding to the POS terminal of the facility may be visible at one or more places (e.g., QR code pasted on wall, queue dividers, or displayed on a screen by the facility) to the user. As explained with reference to FIG. 2, the wallet application 404 is configured to decode the scanned image of the QR code 406 and return an MPQR-compliant object. The MPQR-compliant object also includes a merchant ID of the merchant.

Next, a UI 415 is shown displaying a widget 408 that includes a form field 412 using which the user can enter a transaction amount (exemplarily depicted as ‘$1000’). The form field 412 may allow the user to enter a numerical input to provide the transaction amount. The user can click a button 414 to submit the transaction amount to the issuer server 135. The user can click a button 416 to cancel the transaction. A UI 420 is shown displaying a widget 422 that includes a form field 424 using which the user enters MPIN (exemplarily depicted as ****) associated with his bank account and clicks a button 426 to submit the entry input for verification of transaction. The user can click a button 428 to cancel the transaction.

In one embodiment, the issuer server 135 receives the merchant ID, the transaction amount and the MPIN entered by the user using corresponding UIs via the network 150. As explained with reference to FIG. 2, the issuer server 135 verifies the MPIN entered by the user and upon successful verification only, the transaction is carried forward. In an embodiment, the issuer server 135 detects that the issuer account has insufficient balance and determines to provide a microcredit to the user for processing the current payment transaction. Prior to providing the microcredit, the issuer server 135 sends the merchant ID to the payment server 140 to verify if the merchant is onboarded for receiving the microcredit based payment via the QR code. Only after receiving the successful verification notification from the payment server 140, the issuer server 135 provides the microcredit to the user. This is explained in detail by a UI 425 hereinafter.

The UI 425 is shown to include a plurality of information fields 432, 434 and 436. The information field 432 represents text, ‘your account balance is $500. In an embodiment, the issuer server 135 retrieves additional information of the user account in order to determine a credit limit of the microcredit offer. If it is determined that the user has an active account with multiple transactions made over a period of time, a higher credit limit/loan amount is offered. The information field 434 displays text, ‘we have a credit offer of $550 on 1% interest rate for you’. The information field 436 displays text, ‘click here to read terms and conditions of the offer’. In an embodiment, the user may click on the word ‘here’ which includes a clickable hyperlink for directing the user to another UI (not shown) that enlists the applicable terms and conditions of the offer. For example, it may include a date by which the user has to repay the loan amount. After reading the terms and conditions, the user clicks a button 438 labeled as ‘accept’ to accept the microcredit offer. Alternatively, the user may click a button 440 labeled as ‘reject’ to reject the offer and, in turn, cancel the payment transaction.

Upon receiving user acceptance of the microcredit offer, the issuer server 135 is configured to credit the loan amount $550 to the issuer account. Therefore, the account balance in the issuer account becomes $1050. This amount is used by the issuer server 135 to process the payment transaction. A UI 430 is shown to include information fields 442 and 444. The information field 442 represents text, ‘your payment transaction of $1000 is successful’. The information field 444 represents text, ‘your account balance is $50. The UI 430 also includes a button 446 labelled ‘exit’. By clicking the button 446, the user is redirected to a home page of the wallet application 404. Further, the debited transaction amount of $1000 is sent to the acquirer server 130 for crediting the acquirer account with the transaction amount to complete the payment transaction.

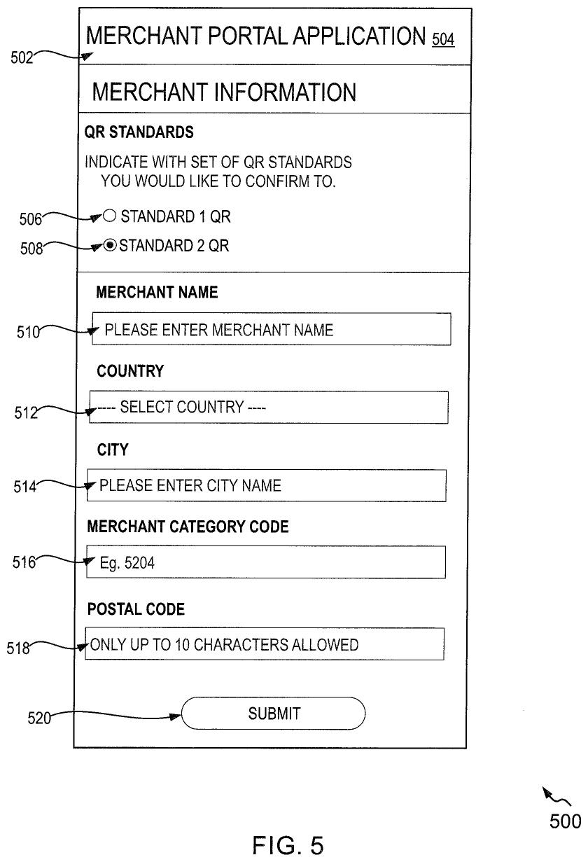

FIG. 5 represents a simplified schematic representation of an example User Interface (UI) 500 of a registration request of a merchant to receive a microcredit based payment via a machine-readable optical label, in accordance with an example embodiment. More specifically, the UI 500 is facilitated by the payment server 140 using which an authorized user of the acquirer bank is enabled to send the registration request. In an example embodiment, the UI 500 may be referred to as a merchant portal facilitated by the payment server 140. In another example embodiment, the merchant himself is enabled to send the registration request on the merchant portal.

The UI 500 displays a header 502 of a merchant portal application 504 (hereinafter alternatively referred to as the merchant portal 504). The UI 500 includes another header labeled as ‘merchant information’. Under the header ‘merchant information’, a plurality of form fields, selectable icons and scrollable lists are displayed. For example, a selectable icon 506 represents text, ‘Standard 1 QR’ and a selectable icon 508 represents text, ‘Standard 2 QR’ for confirming the user preference of the QR standards. The selectable icon 508 (i.e., Standard 2 QR′) is shown to be selected by the user. The UI 500 includes a form field 510 using which the merchant name is entered. A scrollable list 512 is provided for selecting the country of the merchant. Form fields 514, 516 and 518 are respectively used to enter the city of the merchant, the merchant category code and the postal code of the city. The user is enabled to click a button 520 labeled ‘submit’ to submit the merchant information as entered therein using the form fields of the UI 500. Additional information such as currency code, transaction amount (in case of requesting a dynamic QR code), tip or conveyance indicator, bill number, mobile number, store ID, loyalty number, reference ID, terminal ID, consumer ID, alternate language, alternate merchant name, alternate merchant city, and the like may be required to be filled in using corresponding UIs (not shown) for submitting the registration request.

In one embodiment, the payment server 140 receives these merchant parameters from the merchant portal 504 as part of the registration request to onboard the merchant. The payment server 140 assigns/generates a merchant ID for the merchant. This merchant ID is mapped with the plurality of merchant parameters received in the registration request. The information is stored in the mapping database. In one embodiment, the assigned merchant ID is matched with the merchant ID received in the QR code scanned by the user at the merchant facility to verify if the merchant is successfully onboarded. Thus, assignment of merchant ID and its use for the verification purposes plays a significant role in the process of providing microcredits to the users.

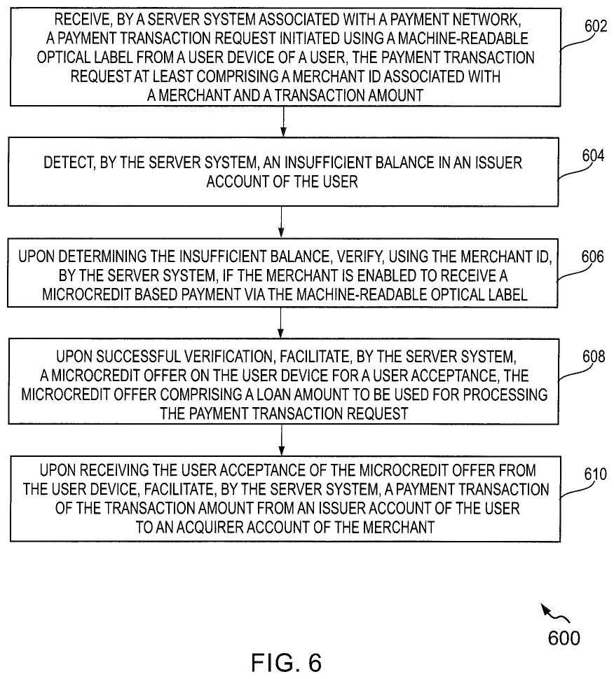

FIG. 6 illustrates a flow diagram of a method 600 for facilitating microcredit for processing a payment transaction, in accordance with an example embodiment. The method 600 depicted in the flow diagram may be executed by, for example, the at least one server system such as an issuer server. The Operations of the flow diagram 600, and combinations of operation in the flow diagram 600, may be implemented by, for example, hardware, firmware, a processor, circuitry and/or a different device associated with the execution of software that includes one or more computer program instructions. The method 600 starts at operation 602.

At 602, the method 600 includes receiving, by a server system associated with a payment network, a payment transaction request initiated using a machine-readable optical label from a user device of a user. The payment transaction request at least includes a merchant ID associated with a merchant and a transaction amount.

At 604, the method 600 includes detecting, by the server system, an insufficient balance in an issuer account of the user.

At 606, the method 600 includes verifying, using the merchant ID, by the server system, if the merchant is enabled to receive a microcredit based payment via the machine-readable optical label.

Upon successful verification, at 608, the method 600 includes facilitating, by the server system, a microcredit offer on the user device for user acceptance. The microcredit offer includes a loan amount to be used for processing the payment transaction request.

Upon user acceptance of the microcredit offer, at 610, the method 600 includes facilitating, by the server system, a payment transaction of the transaction amount from the issuer account of the user to an acquirer account of the merchant. The method 600 ends at operation 610.

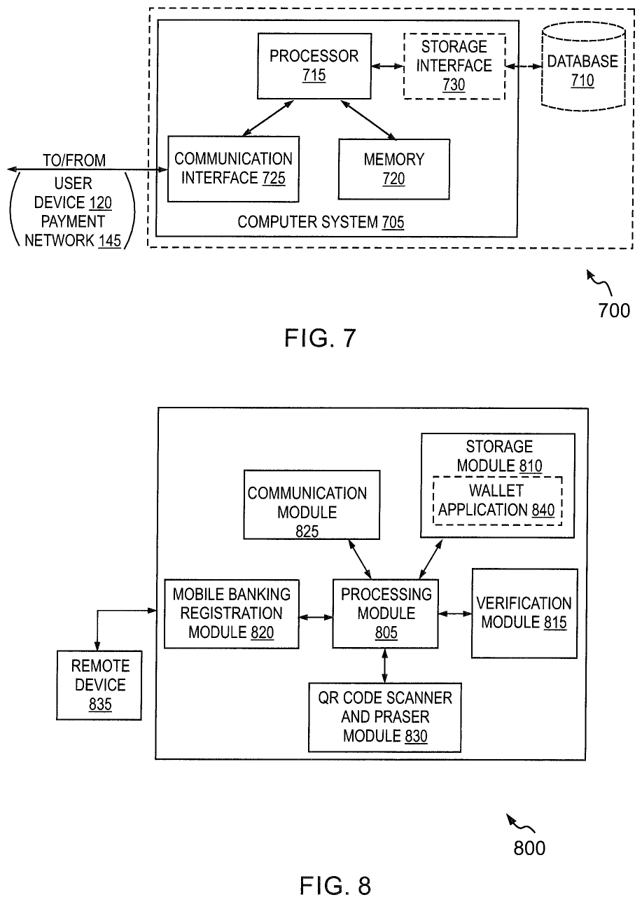

FIG. 7 is a simplified block diagram of a server system 700, in accordance with one embodiment of the present disclosure. The server system 700 is an example of a server system that is a part of the payment network 145. Examples of the server system 700 includes, but not limited to, the acquirer server 130, the issuer server 135 and the payment server 140. The server system 700 includes a computer system 705 and a database 710. The computer system 705 includes at least one processor 715 for executing instructions. Instructions may be stored in, for example, but not limited to, a memory 720. The processor 715 may include one or more processing units (e.g., in a multi-core configuration).

The processor 715 is operatively coupled to a communication interface 725 such that computer system 705 is capable of communicating with a remote device such as the user mobile phone 120 or communicating with any entity within the payment network 145. For example, the communication interface 725 may receive the payment transaction request from the mobile phone 120 associated with the user 115.

The processor 715 may also be operatively coupled to the database 710. The database 710 is any computer-operated hardware suitable for storing and/or retrieving data, such as, but not limited to, transaction data generated as part of sales activities conducted over the bankcard network including data relating to merchants, account holders or customers, and purchases. The database 710 may also store information related to a plurality of user's payment accounts. Each user account data includes at least one of a user name, a user address, an account number, MPIN, credit history and other account identifier. The database 710 may also store a listing of a plurality of merchant parameters and the merchant ID associated with each merchant registered to use the payment network. The database 710 may also include instructions for settling transactions including merchant bank account information. The database 710 may include multiple storage units such as hard disks and/or solid-state disks in a redundant array of inexpensive disks (RAID) configuration. The database 710 may include a storage area network (SAN) and/or a network attached storage (NAS) system.

In some embodiments, the database 710 is integrated within computer system 705. For example, computer system 705 may include one or more hard disk drives as the database 710. In other embodiments, the database 710 is external to computer system 705 and may be accessed by the computer system 705 using a storage interface 730. The storage interface 730 is any component capable of providing the processor 715 with access to the database 710. The storage interface 730 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 715 with access to the database 710.

The processor 715 is configured to perform verification of merchant ID, transaction amount and MPIN for authentication of the payment transaction request by communicating with the database 710. The processor 715 is further configured to approve the transaction amount by checking the available balance in the issuer account of the user, as stored in the database 710. If the available balance in the issuer account is less than the transaction amount, the processor 715 is configured to facilitate a microcredit offer on the user device 120 using corresponding UI upon verifying that the merchant is onboarded to receive the microcredit based payment via a machine-readable optical label. The processor 715 is further configured to verify the MPIN entered by the user from corresponding MPIN stored in the database 710. The processor 715 is configured to facilitate the payment transaction of the transaction amount from the issuer account of the user to acquirer account of the merchant based on user acceptance of the microcredit offer. The processor 715 is configured to notify the user device 120 and merchant device 122 of the transaction status via the communication interface 725.

The components of the server system 700 provided herein may not be exhaustive, and that the server system 700 may include more or fewer components than that of depicted in FIG. 7. Further, two or more components may be embodied in one single component, and/or one component may be configured using multiple sub-components to achieve the desired functionalities. Some components of the server system 700 may be configured using hardware elements, software elements, firmware elements and/or a combination thereof.

FIG. 8 is a simplified block diagram of an issuer server 800, in accordance with one embodiment of the present disclosure. The issuer server 800 is an example of the issuer server 135 of FIG. 1, or may be embodied in the issuer server 135. The issuer server 800 is associated with an issuer bank/issuer, in which a user may have an account, which provides a microcredit offer dynamically during an electronic payment transaction. The issuer server 800 includes a processing module 805 operatively coupled to a storage module 810, a verification module 815, a mobile banking registration module 820, a communication module 825 and a QR code scanner and parser module 830.

The storage module 810 is configured to store machine executable instructions to be accessed by the processing module 805. The storage module 810 includes program instructions for facilitating a wallet application 840. The processing module 805 is capable of executing the stored machine executable instructions of the wallet application 840 (e.g., the wallet applications 124 of FIG. 1 or the wallet application 404 of FIG. 4) in the storage module 810 or within the processing module 805 or any storage location accessible to the processing module 805. Additionally, the storage module 810 stores information related to, contact information of the user, bank account number, BINs, payment card details (if at all purchased by the user), mobile numbers of the users for facilitating mobile banking, internet banking information, PINs, MPINs for mobile banking and the like. This information is retrieved by the processing module 805 for cross-verification during payment transactions.

The mobile banking registration module 820 is configured to facilitate a user to register/enroll for USSD based payment transactions, IMPS based payment transactions and the like using his mobile phone number. In one embodiment, the mobile banking registration module 820 includes logics to generate MPIN that is uniquely associated with each registered mobile phone number of the user and needs to be authenticated for processing the mobile banking based payment transactions. The MPINs generated by the mobile banking registration module 820 are stored in the storage module 810 for later retrieval by the processing module 805 for verification purposes.

The QR code scanner and parser module 830 is configured to use the device camera of the mobile phone 120 to scan the QR code image of the QR code displayed in the merchant facility. The module 830 is further configured to decode the scanned image and return an MPQR-compliant object. The MPQR-compliant object includes QR information such as the merchant ID of the merchant. The merchant ID is sent by the processing module 805 to the payment server 140 via the communication module 825 to verify if the merchant is enabled to receive the microcredit based payments.

The processing module 805 is configured to communicate with one or more remote devices such as the remote device 835 using the communication module 825 over a network such as the network 150 or the payment network 145 of FIG. 1. The examples of the remote device 835 include, the merchant device 122, the user device 120, the payment server 140, the acquirer server 130, other computing systems of issuer and payment network 145 and the like. The communication module 825 is capable of facilitating such operative communication with the remote devices and cloud servers using API (Application Program Interface) calls. The communication module 825 is further configured to cause display of user interfaces (UIs) on the user device 120 to enable the user to enter transaction amount, MPIN etc., scan the QR code, facilitate the microcredit offer etc. on the various UIs of the user device 120.

The processing module 805, in conjunction with the verification module 815, is configured to verify the MPIN (e.g., whether the four-digit numeric code matches the MPIN issued by the issuer), the sufficient funds in the issuer account, and the like. Upon successful verification only, the payment transaction is processed further by the processing module 805. Moreover, upon detection of insufficient balance in the issuer account, the microcredit offer is displayed using a UI for user acceptance instead of cancelling the payment transaction altogether. The processing module 805 is configured to retrieve credit history of the user from the storage module 810 in order to determine a credit limit of the microcredit offer. If the user accepts the microcredit offer, the loan amount is credited in the issuer by the processing module 805 and the transaction amount is debited from the loan amount from the issuer account of the user.

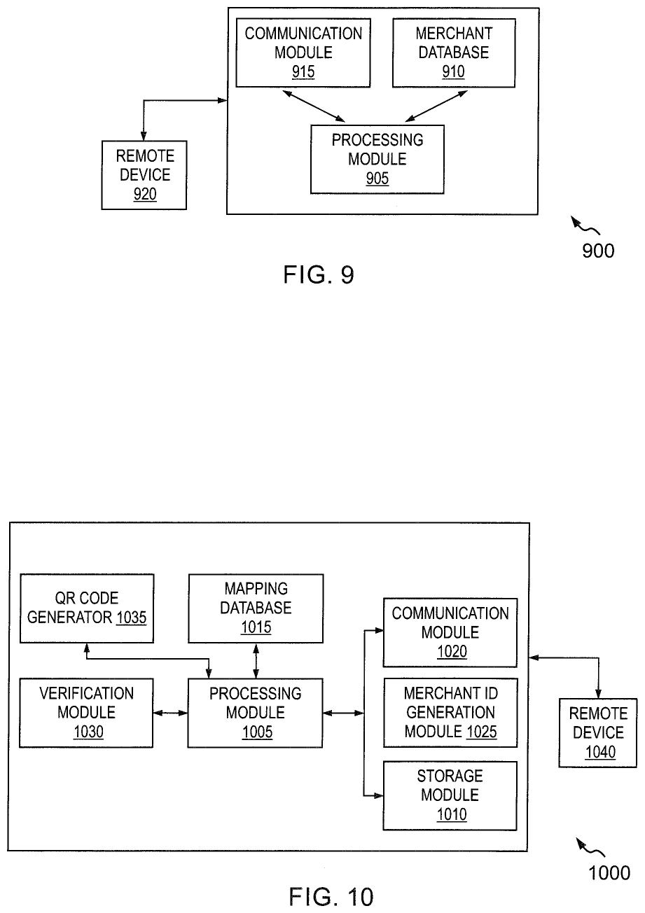

FIG. 9 is a simplified block diagram of an acquirer server 900, in accordance with one embodiment of the present disclosure. The acquirer server 900 is associated with the acquirer bank of a merchant where the merchant has established an account to accept payment using the microcredit based payment transactions. The acquirer server 900 is an example of the acquirer server 130 of FIG. 1, or may be embodied in the acquirer server 130. Further, the acquirer server 900 is configured to facilitate microcredit based payment transaction with the issuer server 800 using the payment network 145 of FIG. 1. Further, the acquirer server 900 is configured to register the merchant for receiving the microcredit based payments using the payment server 140 using the payment network 145.

The acquirer server 900 includes a processing module 905 communicably coupled to a merchant database 910 and a communication module 915. The components of the acquirer server 900 provided herein may not be exhaustive, and that the acquirer server 900 may include more or fewer components than that of depicted in FIG. 9. Further, two or more components may be embodied in one single component, and/or one component may be configured using multiple sub-components to achieve the desired functionalities. Some components of the acquirer server 900 may be configured using hardware elements, software elements, firmware elements and/or a combination thereof.

The merchant database 910 includes one or more merchant parameters, such as, but not limited to, a merchant primary account number (PAN), a merchant name, a merchant category code (MCC), a merchant city, a merchant postal code, a merchant brand name, a request ID to generate a merchant ID, merchant country, terminal identification numbers (TIDs) associated with merchant equipment (e.g., the POS terminals or any other merchant electronic devices) used for processing transactions and the like. The processing module 905 is configured to send a registration request along with the plurality of merchant parameters stored in the merchant database 910 to the payment server 140. The registration request is for onboarding the merchant to receive the microcredit based payment via the QR code. The registration request and the plurality of merchant parameters sent via the communication module 915 to the payment server 140. The processing module 905 is configured to use any of the merchant parameters such as the merchant PAN to identify the merchant during the normal processing of payment transactions, adjustments, chargebacks, end-of-month fees and so forth. The processing module 905 may be configured to store and update the merchant parameters in the merchant database 910 for later retrieval.

In an embodiment, the communication module 915 is capable of facilitating operative communication with the remote device 920 (e.g., the issuer server 800, the merchant device 122, the user device 120 and/or the payment server 140) using API calls. The communication may be achieved over a communication network, such as the network 150. Upon creation of the merchant ID by the payment server 140, the processing module 905 may receive the merchant PAN mapped to the merchant ID to credit the transaction amount to the acquirer account of the merchant.

FIG. 10 is a simplified block diagram of a payment server 1000, in accordance with one embodiment of the present disclosure. The payment server 1000 may correspond to payment server 140 of FIG. 1. As explained with reference to FIG. 1, the payment server 140 is associated with a payment network 145. The payment network 145 may be used by the issuer server 800 and the acquirer server 900 as a payment interchange network. Examples of payment interchange network include, but not limited to, Mastercard® payment system interchange network. The payment server 1000 includes a processing module 1005 configured to extract programming instructions from a storage module 1010 to provide various features of the present disclosure. The components of the payment server 1000 provided herein may not be exhaustive, and that the payment server 1000 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

Via a communication module 1020, the processing module 1005 receives a registration request to receive microcredit based payments using the QR codes from a remote device 1040 such as the acquirer server 900 or the merchant device 122 of FIG. 1. The communication may be achieved through API calls, without loss of generality. The processing module 1005 is configured to facilitate one or more registration APIs using which the registration request is received. Further, a merchant portal/UI such as the UI 500 of FIG. 5 may be facilitated via the communication module 1020 to enter the plurality of merchant parameters for submitting the registration request. A merchant ID generation module 1025 is operatively coupled to the processing module 1005. The merchant ID generation module 1025 is configured to generate/assign a merchant ID based on the request received from the acquirer server 900 over the API calls. Without loss of generality, the merchant ID is mapped to the plurality of merchant parameters. The merchant ID and the mapped merchant parameters are stored in a mapping database 1015 which is to be utilized by the processing module 1005 to retrieve later.

Apart from the merchant ID and the merchant parameters, the mapping database 1015 stores payment card details (if opted by the user), BINs, MPINs, the transaction amount, acquirer account information, transaction records, merchant account information, and the like. A QR code generator 1035 is configured to generate a QR code for the merchant to be displayed in the merchant facility for the user device to scan it to initiate the payment transaction request. The QR code generator 1035 includes logics of generating static QR codes as well as dynamic QR codes. The merchant needs to select preferred option while registering using the merchant portal. Further, the processing module 1005 may facilitate a dedicated application capable of being installed on the merchant device 122. The merchant may be enabled to generate the dynamic QR code, view the transaction status, update customer information, and the like using the application on his device.

In one embodiment, the processing module 1005 receives a verification request from the issuer server 800 to verify if the merchant is onboarded for receiving the microcredit based payments via the QR codes. This request is received via the communication module 1020. The merchant ID received in the payment transaction request based on scanning the QR code by the user device is sent along with the verification request to the processing module 1005. The processing module 1005, in conjunction, with a verification module 1030 is configured to verify the merchant ID with the assigned merchant ID retrieved from the mapping database 1015. The verification module 1030 may include one or more predefined rule sets using which the processing module 1005 can process the verification. Further, the processing module 1005, upon successful verification, notifies the issuer server 800 via the communication module 1020.

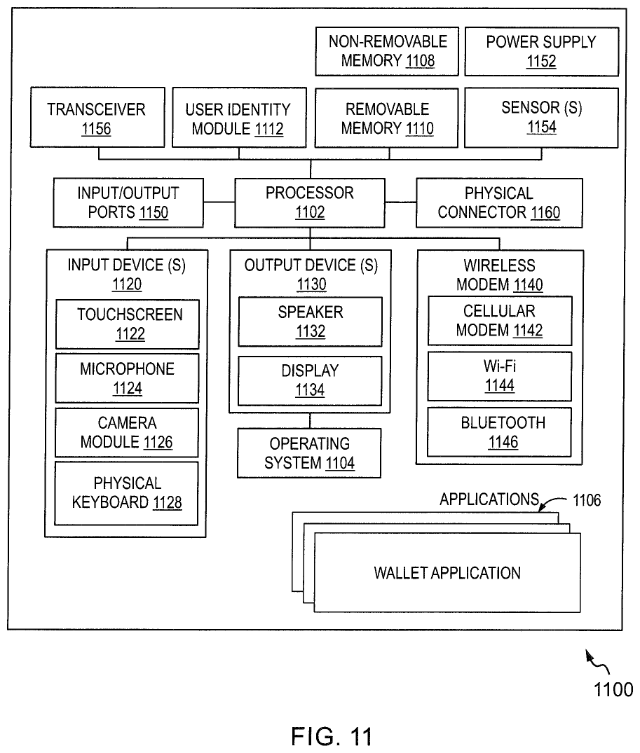

FIG. 11 shows simplified block diagram of a user device 1100 for example a mobile phone or a desktop computer capable of implementing the various embodiments of the present disclosure. For example, the user device 1100 may correspond to the user device 120 of FIG. 1. The user device 1100 is depicted to include one or more applications such as a wallet application 1106 which is an example of the wallet application 124 of FIG. 1 or the wallet application 404 of FIG. 4. The wallet application 1106 can be an instance of an application downloaded from any of the servers 130, 135, and 140 or a third-party wallet server. The wallet application 1106 is capable of communicating with any of the servers 130, 135, and 140 for facilitating microcredit based payment transactions.

It should be understood that the user device 1100 as illustrated and hereinafter described is merely illustrative of one type of device and should not be taken to limit the scope of the embodiments. As such, it should be appreciated that at least some of the components described below in connection with that the user device 1100 may be optional and thus in an example embodiment may include more, less or different components than those described in connection with the example embodiment of the FIG. 11. As such, among other examples, the user device 1100 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1100 includes a controller or a processor 1102 (e.g., a signal processor, microprocessor, ASIC, or other control and processing logic circuitry) for performing such tasks as signal coding, data processing, image processing, input/output processing, power control, and/or other functions. An operating system 1104 controls the allocation and usage of the components of the user device 1100 and support for one or more payment transaction applications programs (see, the applications 1106) such as the wallet application, that implements one or more of the innovative features described herein. In addition, to the wallet application, the applications 1106 may include common mobile computing applications (e.g., telephony applications, email applications, calendars, contact managers, web browsers, messaging applications) or any other computing application.

The illustrated user device 1100 includes one or more memory components, for example, a non-removable memory 1108 and/or removable memory 1110. The non-removable memory 1108 and/or the removable memory 1110 may be collectively known as a database in an embodiment. The non-removable memory 1108 can include RAM, ROM, flash memory, a hard disk, or other well-known memory storage technologies. The removable memory 1110 can include flash memory, smart cards, or a Subscriber Identity Module (SIM). The one or more memory components can be used for storing data and/or code for running the operating system 1104 and the applications 1106. The user device 1100 may further include a user identity module (UIM) 1112. The UIM 1112 may be a memory device having a processor built in. The UIM 1112 may include, for example, a subscriber identity module (SIM), a universal integrated circuit card (UICC), a universal subscriber identity module (USIM), a removable user identity module (R-UIM), or any other smart card. The UIM 1112 typically stores information elements related to a mobile subscriber. The UIM 1112 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1100 can support one or more input devices 1120 and one or more output devices 1130. Examples of the input devices 1120 may include, but are not limited to, a touch screen/a display screen 1122 (e.g., capable of capturing finger tap inputs, finger gesture inputs, multi-finger tap inputs, multi-finger gesture inputs, or keystroke inputs from a virtual keyboard or keypad), a microphone 1124 (e.g., capable of capturing voice input), a camera module 1126 (e.g., capable of capturing still picture images and/or video images) and a physical keyboard 1128. Examples of the output devices 1130 may include, but are not limited to a speaker 1132 and a display 1134. Other possible output devices can include piezoelectric or other haptic output devices. Some devices can serve more than one input/output function. For example, the touch screen 1122 and the display 1134 can be combined into a single input/output device.

A wireless modem 1140 can be coupled to one or more antennas (not shown in the FIG. 11) and can support two-way communications between the processor 1102 and external devices, as is well understood in the art. The wireless modem 1140 is shown generically and can include, for example, a cellular modem 1142 for communicating at long range with the mobile communication network, a Wi-Fi compatible modem 1144 for communicating at short range with an external Bluetooth-equipped device or a local wireless data network or router, and/or a Bluetooth-compatible modem 1146. The wireless modem 1140 is typically configured for communication with one or more cellular networks, such as a GSM network for data and voice communications within a single cellular network, between cellular networks, or between the user device 1100 and a public switched telephone network (PSTN).

The user device 1100 can further include one or more input/output ports 1150, a power supply 1152, one or more sensors 1154 for example, an accelerometer, a gyroscope, a compass, or an infrared proximity sensor for detecting the orientation or motion of the user device 1100 and biometric sensors for scanning biometric identity of an authorized user, a transceiver 1156 (for wirelessly transmitting analog or digital signals) and/or a physical connector 1160, which can be a USB port, IEEE 1294 (FireWire) port, and/or RS-232 port. The illustrated components are not required or all-inclusive, as any of the components shown can be deleted and other components can be added.

The disclosed method with reference to FIG. 6, or one or more operations of the method 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 700 and its various components such as the computer system 705 and the database 710 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a server system associated with a payment network, a payment transaction request initiated using a machine-readable optical label from a user device of a user, the payment transaction request at least comprising a merchant ID associated with a merchant and a transaction amount;
detecting, by the server system, if there is an insufficient balance in an issuer account of the user;
upon determining the insufficient balance, verifying, using the merchant ID, by the server system, if the merchant is enabled to receive a microcredit based payment via the machine-readable optical label;
upon successful verification, facilitating, by the server system, a microcredit offer on the user device for a user acceptance, the microcredit offer comprising a loan amount to be used for processing the payment transaction request; and
upon receiving the user acceptance of the microcredit offer from the user device, facilitating, by the server system, a payment transaction of the transaction amount from the issuer account of the user to an acquirer account of the merchant.

2. The method as claimed in claim 1, wherein the server system is an issuer server configured to facilitate the issuer account to the user.

3. The method as claimed in claim 1, wherein facilitating the microcredit offer on the user device for the user acceptance, further comprises setting a credit limit prior to facilitating the microcredit offer on the user device, wherein the credit limit is set based at least on analyzing
an existence time period of the issuer account, and
a number of transactions processed using the issuer account during the existence time period.

4. The method as claimed in claim 1, wherein facilitating the payment transaction, further comprises:
crediting the issuer account with the loan amount;
debiting the transaction amount from the loan amount present in the issuer account; and
crediting the transaction amount to the acquirer account.

5. The method as claimed in claim 1, wherein the server system is a payment server, and wherein the method further comprises:
receiving a registration request for registering the merchant to receive the microcredit based payment via the machine-readable optical label, the registration request comprising a plurality of merchant parameters; and
assigning the merchant ID to the merchant, wherein the merchant ID is mapped with the plurality of merchant parameters in a mapping database.

6. The method as claimed in claim 5, further comprising:
facilitating one or more merchant registration Application Program Interfaces (APIs) to enable the merchant to register for receiving the microcredit based payment via the machine-readable optical label.

7. The method as claimed in claim 5, further comprising:
facilitating generation of the machine-readable optical label by the merchant, the machine-readable optical label to be scanned by the user device to initiate the payment transaction request.

8. The method as claimed in claim 5, further comprising:
receiving the merchant ID for verification if the merchant is enabled to receive the microcredit based payment via the machine-readable optical label; and
matching the merchant ID with the assigned merchant ID mapped with the plurality of merchant parameters from the mapping database.

9. The method as claimed in claim 5, wherein the plurality of merchant parameters comprises one or more of: a merchant name, a merchant category code, a merchant city, a merchant postal code, a merchant brand name, a merchant primary account number (PAN), and a request ID.

10. The method as claimed in claim 1, wherein the machine-readable optical label is a Quick Response (QR) code.

11. A server system in a payment network, the server system comprising:
a communication interface configured to
receive a payment transaction request initiated using a machine-readable optical label from a user device of a user, the payment transaction request at least comprising a merchant ID associated with a merchant and a transaction amount;
a memory comprising executable instructions; and
a processor communicably coupled to the communication interface, the processor configured to execute the instructions to cause the server system to at least:
detect an insufficient balance in an issuer account of the user;
verify, using the merchant ID, if the merchant is enabled to receive a microcredit based payment via the machine-readable optical label;
upon successful verification, facilitate a microcredit offer on the user device for a user acceptance, the microcredit offer comprising a loan amount to be used for processing the payment transaction request; and
upon user acceptance of the microcredit offer, facilitate a payment transaction of the transaction amount from the issuer account of the user to an acquirer account of the merchant.

12. The server system as claimed in claim 11, wherein the server system is an issuer server configured to facilitate the issuer account to the user.

13. The server system as claimed in claim 11, wherein for facilitating the microcredit offer on the user device for the user acceptance, the server system is further caused to set a credit limit prior to facilitating the microcredit offer on the user device, wherein the credit limit is set based at least on analyzing:
an existence time period of the issuer account; and
a number of transactions processed using the issuer account during the existence time period.

14. The server system as claimed in claim 11, wherein for facilitating the payment transaction, the server system is further caused to:
credit the issuer account with the loan amount;
debit the transaction amount from the loan amount present in the issuer account; and
credit the transaction amount to the acquirer account.

15. The server system as claimed in claim 11, wherein the server system is a payment server, and wherein the server system is further caused to:
receive a registration request for registering the merchant to receive the microcredit based payment via the machine-readable optical label, the registration request comprising a plurality of merchant parameters; and
assign the merchant ID to the merchant, wherein the merchant ID is mapped with the plurality of merchant parameters in a mapping database.

16. The server system as claimed in claim 15, the server system is further caused to:
facilitate one or more merchant registration Application Program Interfaces (APIs) to enable the merchant to register for receiving the microcredit based payment via the machine-readable optical label.

17. The server system as claimed in claim 15, the server system is further caused to:
facilitate generation of the machine-readable optical label by the merchant, the machine-readable optical label to be scanned by the user device to initiate the payment transaction request.

18. The server system as claimed in claim 15, the server system is further caused to:
receive the merchant ID for verification if the merchant is enabled to receive the microcredit based payment via the machine-readable optical label; and
match the merchant ID with the assigned merchant ID mapped with the plurality of merchant parameters from the mapping database.

19. A server system in a payment network, comprising:
a communication module configured to
receive a registration request for registering a merchant to receive a microcredit based payment via a machine-readable optical label, the registration request comprising a plurality of merchant parameters, and
receive a verification request to verify if a merchant is registered to receive the microcredit based payment via the machine-readable optical label, the verification request comprising a merchant ID received as a part of a payment transaction request initiated by a user device of a user via the machine-readable optical label, wherein the payment transaction request comprises a transaction amount;
a storage module comprising executable instructions; and
a processing module communicably coupled to the communication module, the processing module configured to execute the instructions to cause the server system to at least
facilitate generation of the machine-readable optical label by the merchant, the machine-readable optical label to be scanned by the user to initiate the payment transaction request,
facilitate one or more merchant registration Application Program Interfaces (APIs) to enable the merchant to register for receiving the microcredit based payment via the machine-readable optical label,
assign a merchant ID to the merchant, the merchant ID mapped with the plurality of merchant parameters in a mapping database, and
verify if the assigned merchant ID matches with the merchant ID received in the payment transaction request, wherein, upon successful match, a payment transaction of the transaction amount from an issuer account of the user to an acquirer account of the merchant is facilitated.

20. The server system as claimed in claim 19, wherein the server system is an issuer server, and the server system is further caused to:
facilitate a microcredit offer on the user device for user acceptance, wherein the microcredit offer comprises a loan amount to be used for processing the payment transaction request and wherein the microcredit offer is facilitated based on successful match of the merchant ID with the assigned merchant ID of the merchant.
